(19) United States
(12) Patent Application Publication
(10) Pub. No.: US 2025/0373750 A1
(43) Pub. Date: Dec. 4, 2025

(54) Method for Printing a Decoration Onto a Carrier Material

(71) Applicant: SWISS KRONO Tec AG, Luzern (CH)

(72) Inventor: Sebastian Dicke, Bantikow (DE)

(21) Appl. No.: 18/874,299

(22) PCT Filed: Jun. 8, 2023
(86) PCT No.: PCT/EP2023/065373

§ 371 Date: Dec. 12, 2024

(30) Foreign Application Priority Data
Jun. 13, 2022 (EP) 22178651.0

(51) Int. Cl. H04N 1/60

(52) U.S. Cl. CPC H04N 1/6097; H04N 1/6091

(57) ABSTRACT

A method for digitally printing a decoration onto a carrier material is provided including providing an analogue decoration; creating and saving at least one digital image thereof in the form of digital decoration raw data in the RGB colour space; digitally processing at least a part of the digital decoration raw data and creating processed digital decoration raw data; providing at least one set of printing parameters; transferring the processed digital decoration raw data and the at least one set of printing parameters to colour management or RIP software and calculating colour-space-profiled production data for the at least one set of printing parameters from the processed digital decoration raw data; calculating separation data from the colour-space-profiled production data outputting a digital image of the analogue decoration onto a carrier material using a digital printer, including the printing parameters for which the colour-space-profiled production data have been calculated.

### CROSS-REFERENCE TO RELATED APPLICATIONS

This application is the United States national phase of International Patent Application No. PCT/EP2023/065373 filed Jun. 8, 2023, and claims priority to European Patent Application No. 22178651.0 filed Jun. 13, 2022, the disclosures of each of which are hereby incorporated by reference in their entireties.

### BACKGROUND

### Technical Field

The present disclosure relates to a method for digitally printing a decoration onto a carrier material by use of at least one set of defined printing parameters.

### Technical Considerations

Usually, for the production of decorations, for example for floor panels, furniture components or worktops, printing cylinders are used in a gravure printing process. A print decoration in this case is usually created from a digitized analog decoration that is available as a real material such as, for example, wood. The digital data of the analog decoration, i.e., its digital images, are usually generated by scanning or digital photography. Due to the red/green/blue sensors in digital cameras or scanners, these images are captured and saved in the RGB (red, green, blue) color space. The RGB color space is an additive color space that reproduces color perceptions by additively mixing the primary colors red, green and blue. In order to transfer this digital RGB decoration data set to a printing cylinder set that has a plurality of individual colors, the data for the individual colors to be used for printing must be separated.

In the meantime, digital printing is becoming increasingly popular in decorative printing alongside the historically evolved gravure printing. In digital printing, the print design is transferred directly from a computer to a digital printer such as, for example, a laser printer or inkjet printer. Digital printing therefore does not require static printing forms, which means that there is no limit to the length and width of the print design. Digital printing therefore offers a high degree of flexibility and variability in respect of the print motifs and does not impose any restrictions on the pattern repeat. In printing, pattern repeat refers to a constantly recurring, identical print design.

One of the best-known color models is the CMYK color model, which uses the primary colors cyan, magenta, yellow and black for printing. The CMYK color model is a subtractive color model, the abbreviation CMYK for the three color components cyan, magenta, yellow and the black component key as color depth. This color system can be used to depict a color space (gamut) that meets many requirements from a great variety of sectors. If a digital printer uses the CMYK color model, the digital printer accordingly has 4 color channels, namely one color channel for cyan, one color channel for magenta, one color channel for yellow and one color channel for key.

According to the prior art, the digital data are color-space-profiled. This involves taking into consideration the printing parameters relevant for the print, such as
type of printing installation (this comprises printing speed, print-head properties, etc.);
color model to be used for printing (e.g., 4-colour channel system, 5-colour channel system, use of spot colors, etc.);
temperature;
air humidity;
type/batch of printing ink;
type/batch of carrier material to be printed;
pre-treatment of the carrier material (e.g., by priming).

### SUMMARY

In some non-limiting embodiments, the present disclosure provides a method comprising:
i. providing an analog decoration;
ii. from the analog decoration, generating and saving at least one digital image in the form of digital decoration raw data in the RGB color space;
iii. digitally processing at least a portion of the digital decoration raw data in the RGB color space and generating processed digital decoration raw data;
iv. providing at least one set of printing parameters;
v. transferring the processed digital decoration raw data and the at least one set of printing parameters to a color management or Raster Image Processor (RIP) software and calculating, from the processed digital decoration raw data, color-space-profiled production data for the at least one set of printing parameters;
vi. calculating separation data from the color-space-profiled production data calculated for the at least one set of printing parameters;
vii. outputting a digital image of the analog decoration with the calculated separation data onto a carrier material by use of a digital printer, wherein the digital printer is comprised by the at least one set of printing parameters for which a color-space-profiled production have been calculated.

The printing parameters in this case determine the color space that may be represented in the print. The color space describes the entirety of the colors that can be represented with the given printer parameters. In principle, the color space of the color-space-profiled production data, i.e., the digital data following color space profiling, is smaller than the RGB color space in which the digital data of the analog decoration is present, as the color space is restricted by the printing parameters.

The type of printing ink changes the appearance of the printed colors, e.g., due to the pigments contained in the ink. Moreover, even different batches the same printing inks exhibit differences in appearance during printing. The same applies to the carrier material that is printed. All other printing parameters being equal, a print on a wood-based panel will have a different appearance than a print on a glossy paper. Even in the case of printing on a paper, the appearance of the printed colors depends on the paper used, for example whether a paper with a white tone or yellow/brownish paper is used. Furthermore, even papers from different manufacturers differ in respect of their base color. The carrier material may also be pre-treated in various ways, e.g., primed. Priming, in turn, alters the background during printing, and thus the color effect of the print.

Even the choice of printing installation influences the color space in which printing may be effected, as different printing installations have, inter alia, different printing speeds and/or print-head settings, which in turn influence the color space. Furthermore, different printers use different color models for printing.

Climatic conditions during printing also affect the color space; for example, the ink dries at different speeds during printing, depending on the temperature and air humidity.

The color-space-profiled production data of different printing parameters therefore differ from each other and, depending on the printing parameters in each case, may depict color spaces of different sizes.

From the color-space-profiled production data, separation data are calculated for the digital printer used for printing. For digital printing, also, printing companies usually use the separated print data, in a manner similar to that used for gravure printing. For use in digital printing, Raster Image Processor (RIP) software is used to convert the data from a digital image into a format that can be processed by a digital The RIP printer. software separates the color information comprised in the digital image into, inter alia, the color channels that are constituent part of the color model of the digital printer that is to be used for printing. Outputting of the digital print via the digital printer is then effected via the digital printer having the corresponding color model. Separation data may be calculated by means of, for example, an RIP software, a color management software and/or internal printer software.

The separation data, like the profiled production data, therefore depend on the printing parameters. In some non-limiting embodiments, the separation data for printing a decoration will differ on different printing installations. Printing installations are understood here to be digital printers. These may be either alone or in an system comprising further devices, e.g., comprising devices for priming and/or transporting carrier materials.

Until now, the separation data has usually been calculated from the color-space-profiled production data for a print according to defined printing parameters, and then these separation data are digitally processed, for example in order to effect color adaptations to the decoration, or retouching. In the process, the color information present in the color channels is processed and altered.

For the reasons already described, however, the separation data available for one set of printing parameters may not be simply applied to other printing parameters. This means, for example, that the separation data may not simply be used for a different printing installation. It is necessary to calculate new color-space-profiled production data, and thus new separation data, for each changed printing parameter, and then to process this separation data again digitally, such that wanting retouching operations can be performed, such as, for example, color adaptations of the decoration.

EP 3 470 972 A1 discloses a method for the multiple use of digital print data to produce optically and/or haptically high-quality print decorations on a carrier material. In the method, separation data of a digital print motif is created, and the data of the individual color channels may then be processed individually in order to retouch the digital print motif.

However, the prior art has numerous disadvantages. The respective manual separation of the individual colors before printing with a defined set of printing parameters means a large amount of time is required in the production process, thereby increasing production costs. While the digital data of the analog decoration are available in the extensive RGB color space after being created, after the color-space-profiled production data has been calculated and separated the color space of the decoration is restricted to colors and/or spot colors of the color model used in printing. The color-space-profiled production data and the separation data generated by the separation process cover a substantially smaller color space than the original digital data of the analog decoration in the RGB color space. For example, separation data for a second printing installation may not be obtained on the basis of already existing separation data for a first printing installation. In this case, there would generally be a loss in the quality of the printed image accepted.

For example, if separation data are available for printing with a 4-colour system, these data cannot not be used to calculate separation data for printing on a printing installation with a 5-colour system. In this case, data with a lesser information content (for 4 color channels) would have to be used to generate data with a greater information content (for 5 color channels). Thus, a consistently high standard in printing cannot be ensured.

The present disclosure provides a method for digitally printing decorations that can be performed as flexibly as possible with different printing parameters, for example different printing installations, while rectifying the disadvantages of the methods known from the prior art.

### DETAILED DESCRIPTION

According to some non-limiting embodiments of the methods according to the present disclosure, an analog decoration is provided. Basically, all possible materials that exist in reality, and the appearance of which is suitable as decoration, may serve as analog decorations. In some non-limiting embodiments, wood, tile and/or stone surfaces may serve as analog decorations. In some non-limiting embodiments, analog decorations within the meaning of the present disclosure may also be templates that were created by means of other printing techniques such as gravure printing, screen printing and/or even manual techniques. The decorations are popular, for example, in the design of laminates that are used for base, wall and/or ceiling coverings.

In some non-limiting embodiments, the method according to the present disclosure is preferably used for printing carrier materials for the production of flooring laminates or wall and ceiling paneling elements.

At least one digital image, in the form of digital decoration raw data in the RGB color space, is then generated from the analog decoration and saved. In some non-limiting embodiments, the at least one digital image, and thus the digital decoration raw data of the analog decoration, are generated by photographing the analog decoration by means of a digital camera and/or by scanning-in the analog decoration by means of a scanner.

The RGB color space is the largest color space in which digital images can be processed, and comprises all color spaces in which digital printing may be performed.

In some non-limiting embodiments, a plurality of digital images of the analog decoration may be generated. For example, the analog decoration may be photographed, or scanned, at different angles, with the use of different camera or scanner settings. A composite image may then be calculated from the different digital images. Also known from the prior art is software for scanners, in which an analog decoration is scanned in 3 different modes, i.e., under 3 different conditions (scanner settings, exposure, etc.) and a composite image is then generated. In some non-limiting embodiments, the digital composite image may then be further processed digitally. The digital composite image then represents the digital decoration raw data within the meaning of the present disclosure.

During the process of photographing or scanning, in some non-limiting embodiments, special effects such as shading may be created by use of special lighting techniques and varying the position of the camera or scanner over the analog decoration.

According to some non-limiting embodiments, at least a portion of the digital decoration raw data is digitally processed in the RGB color space. In the digital processing of at least a portion of the digital decoration raw data, at least a portion of the decoration raw data may be retouched. According to some non-limiting embodiments, processed digital decoration raw data are thereby generated. According to some non-limiting embodiments, the processed digital decoration raw data are still available in the RGB color space.

In some non-limiting embodiments, the processing of at least a portion of the digital decoration raw data is effected by means of the Adobe Photoshop software. In principle, however, all image processing programs or graphics processing programs that enable digital image data to be processed, for example retouched, in the RGB color space are suitable for this purpose. The processing of the digital decoration raw data may be performed, for example, by a user on a PC by means of a suitable software such as, for example, Adobe Photoshop.

Retouching is the subsequent image processing of the digital decoration raw data of a photographed or scanned analog decoration. In this process,.
one or more color tones may be altered; and/or
the brightness may be altered; and/or.
the saturation may be altered; and/or.
the contrast may be altered; and/or.
the sharpness may be altered.

During the retouching process, the appearance of the digital image described by the digital decoration raw data may be altered in any way. The processing steps mentioned below always relate to altering the appearance of the digital image described by the digital decoration raw data. The digital decoration raw data are processed for this purpose.

Thus, for example, errors in the digital image may be rectified. Furthermore, dust that was present on the analog decoration during digitization may be removed as an visual appearance from the digital image, and thus from the digital decoration raw data. In the case of wood decorations, for example, knotholes may be removed, added and/or altered, e.g., their size. Furthermore, pattern repeats may be created. In some non-limiting embodiments, decorations that are intended for planks are processed in such a way that the plank divisions are no longer visible in the digital image. This has the advantage that, after digital printing in the pattern repeat, planks of any width may be cut from the printed carrier material.

The sharpness of the digital image, or of regions of the digital image, may be altered. Regions may be made sharper or less sharp. Furthermore, highlights and mid-tones may be altered separately in respect of color and saturation.

The retouching processes make it possible to emphasize structures in the digital image of the analog decoration or to make them less prominent, for example by altering the coloring in these regions. For example, pores in wood structures, knotholes or similar markings in decorations may be emphasized or not emphasized. Adobe Photoshop software offers the option of working with multiplication layers. This function may be used to copy a decoration layer in the software and arrange it above another decoration layer. The upper decoration layer in this case may be represented as transparent, as a result of which the underlying decoration layer appears visually enhanced.

The coloring may also be altered during retouching. For example, different color regions may be created in a monochrome decoration, thereby imparting a more dynamic appearance to the entire digital image of the analog decoration. Conversely, colors may also be reduced or adapted in dynamic digital images of an analog decoration, thereby imparting a calmer look to the digital image of the analog decoration.

It is also possible to perform geometric operations such as rotation, mirroring and/or also regrouping of certain parts of the digital image.

The digital decoration raw data may thus be optimally adapted to the customer's requirements. Advantageously, this processing is performed in the largest possible color space available, namely the RGB color space. This means that the maximum quantity of data that may be processed is available.

In some non-limiting embodiments, not only a portion of the decoration raw data is processed, but all of the decoration raw data. This makes it possible to perform retouching processes over the entire digital image or also, alternatively, only for selected sub-regions of the digital image.

As a result of the processing of the decoration raw data, a processed digital image of the analog decoration is created, the appearance (visual impression) of which is altered in comparison to the unprocessed digital image of the analog decoration as it was created in step ii.

According to some non-limiting embodiments, at least one set of printing parameters is provided. According to some non-limiting embodiments, printing parameters are selected from the group comprising
type of printing installation (this comprises printing speed, print-head properties, etc.);
color model to be used for printing (e.g., 4-colour channel system, 5-colour channel system, use of spot colors, etc.);
temperature;
air humidity;
type/batch of printing ink;
type/batch of carrier material to be printed; and/or.
pre-treatment of the carrier material (e.g., by priming).

The properties of the printing parameters are part of the prior art and have already been described at the outset. In this case, a set refers to a collection of printing parameters, there being exactly one defined value or one defined quantity for each printing parameter. In some non-limiting embodiments, a set of printing parameters comprises all of the said printing parameters or, alternatively, a selection thereof. In some non-limiting embodiments, a plurality of sets of printing parameters are provided. In principle, any number of sets of printing parameters may be provided. In some non-limiting embodiments, 2 to 10, or 2 to 6, or 2 to 4 sets of printing parameters are provided.

The processed digital decoration raw data and the at least one set of printing parameters are transferred to a color management or RIP software, and color-space-profiled production data for the at least one set of printing parameters are calculated from the processed digital decoration raw data.

As already described, printing installations are to be understood here as digital printers, alone or in an installation with further devices, e.g., with devices for priming and/or transporting carrier materials. The focus of the present disclosure is on industrial-scale printing installations that work with a high number of items. On an industrial scale, installations may well print 10 million m² of carrier material per year or more under full load. At full capacity, digital paper printing installations having a working width of 200 cm can print 50 million m² of carrier material, or around 3,500 tonnes of paper per year and more. Digital plate printers achieve at least 1 million m² of printed carrier material per year. With such printing installations, the aim is to minimize defective rejects as far as possible, in order to save costs and thus increase the cost-effectiveness of the printing process. In addition, it is sought to realize high-quality prints with a high level of reproducibility.

The printing parameters define, inter alia, which digital printer is to be used for printing. Different digital printers generally also have different printing properties. In this step, therefore, a color space adjustment is made, in which the color-space-profiled production data are no longer available in the RGB color space, but in a smaller, restricted color space. When calculating the color-space-profiled production data, the color model used by the digital printer intended for printing is taken into consideration by the printing parameters. In some non-limiting embodiments, the color-space-profiled production data are calculated in a color model selected from the group comprising CMYK, CRYK, 1-colour, 5-colour, 6-colour, 7-colour and/or even 8-colour color models. The color models in this case may also comprise spot colors.

The color space available during printing is additionally influenced by the printing parameters referred to above. P person skilled in the art is aware of this, and it has already been explained. Calculation of the color-space-profiled production data takes into consideration the influence of the printing parameters on the color space. In this step, the digital data are therefore cropped to the color space that is used in printing with a digital printer according to defined printing parameters.

If a plurality of sets of printing parameters are provided, in some non-limiting embodiments color-space-profiled production data are created for each set of printing parameters. According to some non-limiting embodiments, the creating, or calculating, of the color-space-profiled production data is in each case based on the processed digital decoration raw data. Consequently, the color-space-profiled production data are always created based on the largest possible color space, namely the RGB color space.

According to some non-limiting embodiments, separation data are calculated from the color-space-profiled production data calculated for the at least one set of printing parameters. The separation data in this case are an assignment of the print data to the individual printer heads of the digital printer. A person skilled in the art is familiar with this procedure. In some non-limiting embodiments, the separation data are calculated from the digital production data by a color management, RIP software and/or internal printer software.

According to some non-limiting embodiments, the processed digital image of the analog decoration, with the calculated separation data, is output by a digital printer onto a carrier material, wherein the digital printer is comprised by the at least one set of printing parameters for which the color-space-profiled production data were calculated.

According to some non-limiting embodiments, a digital image of the analog decoration, with the separation data, is output by at least one digital printer according to the printing parameters defined in the at least one set of printing parameters. These printing parameters correspond to the printing parameters on which the calculation of the color-space-profiled production data, from which the separation data was calculated, was based. The printing parameters on which the calculation of the color-space-profiled production data and the separation data were based are therefore also used for printing.

According to some non-limiting embodiments, the appearance of the printed decoration on the carrier material corresponds to the appearance of the processed digital image as represented by the processed decoration raw data.

In some non-limiting embodiments, in step vi. separation data are calculated in each case from the color-space-profiled production data calculated for each set of printing parameters, and in step vii. a digital image of the analog decoration, with the respective calculated separation data, is output by a respective digital printer onto a carrier material. The respectively one digital printer is comprised by the set of printing parameters for which the color-space-profiled production data and the respective separation data were calculated. According to some non-limiting embodiments, the color-space-profiled production data and the separation data calculated therefrom are always calculated in relation to a set of printing parameters, and a digital image is output using precisely those printing parameters by means of the calculated separation data.

Advantageously, color-space-profiled production data and separation data therefrom for printing with different printing parameters, and thus also for different digital printers, may be calculated in this way. However, for example color-space-profiled production data and the separation data therefrom may also be calculated for printing with the same digital printer and color model, but on different carrier materials. The starting point in each case is the processed decoration raw data present in the RGB color space. The color-space-profiled production data and the separation data therefrom may thus always be calculated, advantageously, based on the largest possible color space.

According to some non-limiting embodiments, a graphics department may advantageously undertake the retouching of the digital image of the analog decoration once in the RGB color space simply and quickly, thus saving costs. There is no need to repeatedly process the separation data, as is known from the prior art. Decoration development times are thereby shortened, by several days to several weeks, which represents an enormous competitive advantage. Moreover, it also becomes possible to react more quickly to customer requests.

Furthermore, the separation data no longer need to be digitally post-processed, as is common in the prior art. The digital decoration raw data have already been digitally processed and therefore already comprise the wanted retouching of the digital image of the analog decoration. As a result, a large amount of time can be saved, and the printing process can accordingly be made more economically efficient.

In principle, any material suitable for the application of a print medium is suitable as a carrier material. The carrier material may have a smooth and/or, also, a rough surface to which the print medium is applied. In some non-limiting embodiments, the carrier material is selected from a group comprising paper, glass, metal, foils, wood-based materials, plastics and/or combinations thereof, for example medium-density fiber (MDF) boards, high-density fiber (HDF) boards, chipboards, coarse particle boards (OSB), plywood boards and wood-plastic boards (WPC), veneers, lacquer layers, plastic boards, fiber-reinforced plastic, hard paper and/or inorganic carrier plates.

In some non-limiting embodiments, the carrier material has at least one flat shape that can be printed with the printing forms. Suitable carrier materials may therefore be, for example, laminates, furniture panels, furniture fronts, worktops, door fronts, wallpaper, paper and/or glass surfaces. The carrier material may have a smooth surface and/or, also, a textured surface.

In some non-limiting embodiments, the carrier material may be pretreated. Pretreatment comprises the sanding of the carrier material and/or the application of a primer. If the carrier material is a paper or wallpaper, a pretreatment may also be effected in the form of the application of a primer.

In some non-limiting embodiments, prior to printing at least one primer layer is applied to the side of the carrier material that is to be printed on. For example, when wood-based panels are used as carrier material, in some non-limiting embodiments, prior to printing with the digital image at least one primer layer comprising at least one resin and/or at least one varnish is applied to the side of the wood-based panel to be printed on, which primer layer is then dried and/or cured.

Furthermore, the primer may comprise at least one additive and/or at least one auxiliary substance. Suitable additives are selected from the group comprising hardeners, wetting agents (surfactants or mixtures thereof) and/or release agents. Suitable auxiliary substances are selected from the group comprising conductive substances and/or cellulose. The conductive substances may be selected from the group comprising carbon black, carbon fibers, metal powder and/or nanoparticles, for example carbon nanotubes.

Preferably, the side of the carrier material that is to be printed on, for example a wood-based panel, is sanded before the primer is applied.

For priming, an aqueous resin solution and/or a radiation-curable filling compound may be applied to the side of the carrier material to be printed on. Aqueous resin solutions such as melamine-formaldehyde resin, urea-formaldehyde resin or melamine-urea-formaldehyde resin, for example, can be used as primers. It is also possible to pre-coat, or prime, the carrier material with 1K/2K acrylate, UV and/or ESH filler, and then cure this primer layer accordingly.

Preferably, an aqueous resin solution, for example an aqueous solution of a melamine-formaldehyde resin, urea-formaldehyde resin or melamine-urea-formaldehyde resin, is used for pre-coating, or priming, the carrier material, for example a wood-based panel.

The amount of liquid resin solution applied for priming may be 10 to 80 g/m², or 20 to 50 g/m². The solids content of the aqueous resin solution may be 30 to 80%, or 40 to 60%, or 55%. The liquid resin may additionally comprise suitable wetting agents, hardeners, release agents and/or defoamers.

Following application of the aqueous resin solution to the carrier material for the purpose pre-coating or priming the same, the liquid resin is dried to a moisture content of 10%, or 6%, for example in a convection oven or near-infrared oven.

In some non-limiting embodiments, the carrier material, for example a wood-based panel, may be pre-coated, or primed, with 1K/2K acrylate and/or ESH filler. A UV filling compound advantageously comprises substantially of UV-curable coating components, pigments, reactive thinners and/or radical formers as chain starters.

In some non-limiting embodiments, the amount of filling compound applied may be 50 to 150 g/m², or 50 to 100 g/m². The quantities stated relate to a 100% filling compound.

It is also possible for the filler compound used for priming to be pigmented, enabling the printing result to be varied or improved.

Pre-coating the carrier material with a transparent primer is preferred in some non-limiting embodiments.

In some non-limiting embodiments, prior to printing on the at least one side of the carrier material, for example a wood-based panel, at least one layer of a pigmented primer, which is preferably water-based, is applied to the side of the carrier material that is to be printed on. The pigmented primer may be applied either directly to the untreated surface of the carrier material or, also, to the previous, preferably transparent, primer.

The water-based pigmented primer may also be applied in more than one layer (e.g., 3 to 10 layers, or 5 to 8 layers, or 7 layers), with the pigmented primer being dried, e.g., in a convection dryer or a near-infrared dryer, after each layer application. The water-based pigmented primer preferably comprises at least one pigment of a light color, for example at least one white pigment.

White pigments are achromatic inorganic pigments having a high refractive index (greater than 1.8), which are mainly used to produce optical whiteness in paints or as a filler, for example in plastics. White pigments in some non-limiting embodiments may be selected from the group comprising titanium dioxide, lithopone, barium sulfate, zinc oxide, zinc sulfide and/or calcium sulfate. Lithopone is a white pigment comprising barium sulfate and zinc sulphide. According to some non-limiting embodiments, titanium dioxide is preferably used as the white pigment in the water-based pigmented primer, since titanium dioxide has the highest refractive index and thus the greatest opacity among the known white pigments.

The carrier material may therefore be primed before being printed on, and one or more protective layers, preferably one, two or three protective layers, may optionally be applied after it has been printed on. The at least one protective layer comprises abrasion-resistant particles, natural fibers, synthetic fibers and/or further additives, and resins such as melamine-formaldehyde resin, urea-formaldehyde resin, acrylate resins and/or polyurethane resins may be used as suitable binders.

The abrasion-resistant particles are preferably selected from the group comprising aluminum oxides, corundum, boron carbides, silicon dioxides, silicon carbides, silanised corundum particles and/or glass beads. The application of abrasion-resistant particles and/or glass beads can increase the wear resistance of a carrier material with a decoration and optionally a textured surface. As natural and/or synthetic fibers, fibers selected from the group comprising wood fibers, cellulose fibers, wool fibers, hemp fibers, organic polymer fibers, and/or inorganic polymer fibers are used.

Conductive substances, flame retardants, luminescent substances and/or metals may be comprised as additives. The conductive substances in this case may be selected from the group comprising carbon black, carbon fibers, metal powder and/or nanoparticles, for example carbon nanotubes. Combinations of these substances may also be used. Preferred flame retardants are phosphates, borates, for example ammonium polyphosphate, tris(tri-bromine neopentyl) phosphate, zinc borate and/or boric acid complexes of polyhydric alcohols. Preferred luminescent substances are fluorescent and/or phosphorescent substances of an inorganic or organic base, for example zinc sulfite and/or alkaline earth aluminates.

In some non-limiting embodiments, paper is used as the carrier material. Paper suitable as a printing base paper is preferably white and has a weight of 60 to 90 g/m², or 65 to 80 g/m², or 70 g/m². In some non-limiting embodiments, the paper suitable as a printing base paper is preferably white and has a weight of 50to 90 g/m², or 50 to 70 g/m², or 65 g/m².

A primer is applied to the paper before printing in order to prime it. Suitable agents that may be used as primers are known to a person skilled in the art. In some non-limiting embodiments, the primer comprises water and additives and/or auxiliary substances. Preferably, the primer comprises up to 90% water. Suitable additives are selected from the group comprising hardeners, wetting agents (surfactants or mixtures thereof) and/or release agents. Suitable are auxiliary substances selected from the group comprising conductive substances and/or cellulose. The conductive substances may be selected from the group comprising carbon black, carbon fibers, metal powder and/or nanoparticles, for example carbon nanotubes.

In some non-limiting embodiments, the amount of primer applied is 3 to 20 g/m², or 3 to 10 g/m², or 5 to 6 g/m².

The methods of the present disclosure offer the advantage that the quantity of priming coat or primer used may be adapted to the decoration to be printed.

Print decorations are used, for example, in the production of floor laminate or in the form of wall and/or ceiling paneling elements. In this case, the carrier material is preferably a wood-based panel. In some non-limiting embodiments, the carrier material is therefore a wood-based panel.

In some non-limiting embodiments, the printed carrier material, which may be provided with a protective layer, for example of formaldehyde resins, is further processed, or finished, in a short-cycle press. The resin layers are melted in the short-cycle press and the composite layer is cured to form a laminate.

During further processing in the short-cycle press, a textured press plate may also be used to create surface textures in the surface of the carrier material, such as a wood-based panel, which may optionally be designed to match the decoration (so-called decoration-synchronized texture). In the case of wood decorations, the textured structures may be in the form of pore structures that follow the grain. In many decorations, the textured structures may be indentations in the region of joints and filling lines surrounded by the decoration.

The methods of the present disclosure are explained in greater detail below with reference to a figure and two exemplary embodiments.

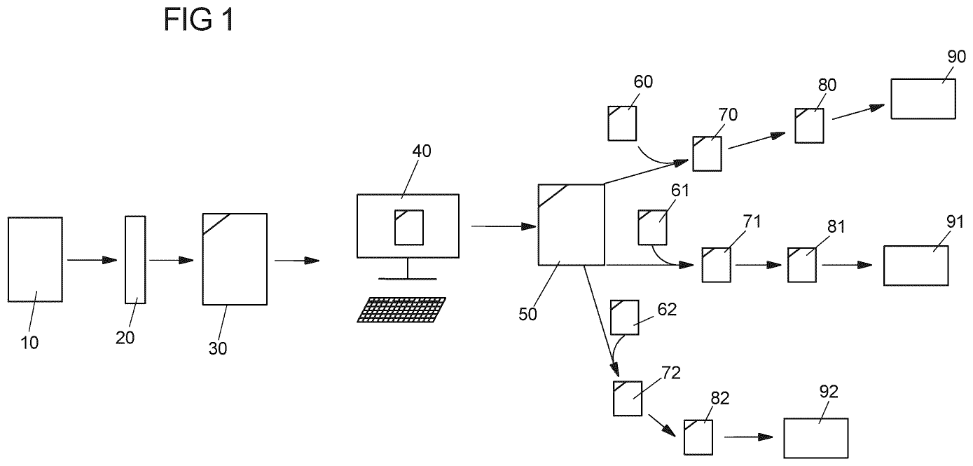

FIG. 1 shows a general sequence of the method.

Represented in FIG. 1 is a general sequence of methods according to some non-limiting embodiments of present disclosure. An analog decoration 10 is provided, from which a digital image, which is available in the form of decoration raw data 30, is created by the device 20. According to some non-limiting embodiments, the device 20 may be, for example, a digital camera or a scanner. The digital decoration raw data 30 are processed and retouched on a PC 40, thereby producing processed decoration raw data 50. Three different sets of printing parameters 60-62 are provided. Color-space-profiled production data 70-72 are calculated from the processed decoration raw data 50 and respectively one set of printing parameters 60-62. Separation data 80-82 are then calculated in each case from the color-space-profiled production data 70-72, and then used for printing onto a carrier material 90-92. The printing takes place in each case according to the printing parameters used for the calculation of the color-space-profiled production data and the associated separation data. That means that the color-space-profiled production data 70 are calculated from the processed decoration raw data 50 and the printing parameters 60. The separation data 80 are calculated from the color-space-profiled production data and 70, then these separation data 80 are used for printing onto the carrier material 90 according to the printing parameters 60.

Advantageously, color-space-profiled production data 70-72 and separation data 80-82 may thus be generated for different sets of printing parameters 60-62, always starting from the processed decoration raw data 50. The processed decoration raw data 50 are available in the RGB color space and thus have the greatest possible information content after the analog decoration 10 has been digitized. The color-space-profiled production data 70-72 and the separation data 80-82, on the other hand, are available for a color model such as, for example, the CMYK color model.

In the prior art, it is common practice to first generate separation data for particular printing parameters, which are retouched, and then to calculate second separation data for other printing parameters from these first retouched separation data. The second separation data are derived from the first and are therefore also based on the color space in which the first separation data were calculated. The color space of the second printing parameters can therefore no longer be larger than the color space of the first printing parameters. This procedure may result in losses in the color information and thus in the print quality if, for example, the first set of printing parameters comprises a printer having a 4-colour system, and the second set of printing parameters comprises a printer having a 5-colour system.

### Exemplary Embodiment 1

In the case of a manufacturer of laminate flooring boards, decorations were printed, on three different digital printing installations, for further processing to produce decorative panels. Thus, for printing on each of the three digital printing installations, there were three different sets of printing parameters available. Firstly, a wooden board made of beech was provided, from which a digital image was taken by means of a digital camera. The digital image was thus available in the form of digital decoration raw data within the meaning of the present disclosure. The digital decoration raw data were retouched with respect to sharpness and contrast, and used to generate processed decoration raw data 50.

The three different digital printing installations comprised two structurally identical paper digital printing installations on which decoration paper rolls were printed by use of a 4-colour system (printing with 4 colors). The third digital printing installation was a digital printing installation that prints on primed wood-based panels by means of a 5-colour system (printing with 5 colors).

The color spaces were greatly influenced by the printing parameters. The white primer on the wood-based panels was substantially darker than the white paper, as a result of which the color space was actually smaller for printing on the primed wood-based panel itself, with otherwise identical printing parameters.

The substrate of the primed wood-based panel had a 3-4 lower L-value compared to the white paper. This meant that the color space was approximately at least ⅓ smaller. The bright, vibrant colors would therefore not have been possible to reproduce in printing with a 4-colour system (color system: CYRK). In order to increase the color space, 5 colors (5-colour system) were therefore used when printing on the wood-based panel. The C Y1 Y2 R K color system was used as the 5-colour system.

From the processed decoration raw data 50, color-space-profiled production data 70-72 were calculated for the three different sets of printing parameters 60-62, and thus for each of the three digital printing installations, by transferring the processed decoration raw data and the printing parameters 60-62 to the RIP software of the respective digital printing installations. The color-space-profiled production data 70-72 for printing with the 4-colour system were calculated on the basis of the same digital processed decoration raw data as the color-space-profiled production data 70-72 for printing with the 5-colour system.

The three sets of printing parameters for which color-space-profiled production data 70-72 were calculated are presented below.

| Printing | | | |
|---|---|---|---|
| parameter | Set 1 | Set 2 | Set 3 |
| Type of | Paper digital | Paper digital | Digital printing |
| printing | printing | printing | installations |
| installation | installations 1 | installations 2 | for printing on |
| | | | wood-based panels |
| Color model | 4-colour system | 4-colour system | 5-colour system |
| | (CYRK) | (CYRK) | (C Y1 Y2 R K) |
| Temperature | 23° C. | 23° C. | 30° C. |
| Printing ink | Manufacturer 1 | Manufacturer 1 | Manufacturer 2 |
| Carrier | White paper | White paper | Wood-based panel |
| material | | | |
| Pretreatment | None | None | White primed |
| of the carrier | | | |
| material | | | |

For printing, separation data 80-82 were calculated in each case from the color-space-profiled production data 70-72. It was possible to perform the printing of a digital image onto the all three sets of carrier material with high quality for printing parameters. In addition, it was possible for color-space-profiled production data 70-72, and from these, separation data 80-82, to be calculated rapidly and effectively for the different sets of parameters. printing Changing printing parameters did not result in delays in the calculation of the separation data, as these were always calculated on the basis of the processed decoration raw data. The method according to the present disclosure is thus more cost-effective than the methods from the prior art.

If the separation data for printing with the 5-colour system had been calculated from the separation data for printing with the 4-colour system, as is common in the prior art, this would have been detrimental to the quality of the separation data for printing in the 5-colour system. This is because the separation data would no longer have been calculated on the basis of the largest possible color space (RGB color space in which the digital production data is available), but on the basis of a smaller color space.

### Exemplary Embodiment 2

In the case of a manufacturer of laminate flooring boards, decorations were printed, on two different digital printing installations, for further processing to produce decorative panels. Thus, for printing on each of the two digital printing installations, there were two different sets of printing parameters available. Firstly, a wooden board made of beech was provided, from which a digital image was taken by means of a digital camera. The digital image was thus available in the form of digital decoration raw data within the meaning of the present disclosure. The digital decoration raw data were retouched with respect to sharpness and contrast, and used to generate processed decoration raw data 50.

The two different digital printing installations comprised two structurally identical paper digital printing installations on which decoration paper rolls were printed by use of a 4-colour system (printing with 4 colors). A white paper was used as the carrier material in each case, with a primer being applied to the paper in one print. The primer used was a primer containing 90% water and 10% additives and auxiliary substances, with an application quantity of 6 g/m².

The color spaces were greatly influenced by the printing parameters. If the paper is printed without a primer, the printing ink penetrates, unhindered, deeply into the rough surface of the paper. In the case of primed paper, however, the additives and fillers in the primer prevent the ink from penetrating deeply into the surface of the paper. This allows a substantially larger color space to be depicted, as the inks, or their pigments, remain attached to the surface and thus increase the color impression compared to when they sink into the paper.

From the processed decoration raw data 50, color-space-profiled production data 70-72 were calculated for the two different sets of printing parameters 60-62, and thus for each of the two digital printing installations, by transferring the processed decoration raw data and the printing parameters 60-62 to the RIP software of the respective digital printing installations. The color-space-profiled production data 70-72 for printing with the 4-colour system on the two digital printing installations were in each case calculated on the basis of the same digital processed decoration raw data.

The two sets of printing parameters for which color-space-profiled production data 70-72 were calculated are presented below.

| Printing parameter | Set 1 | Set 2 |
|---|---|---|
| Type of printing | Paper digital printing | Paper digital printing |
| installation | installations 1 | installations 2 |
| Color model | 4-colour system | 4-colour system |
| | (CYRK) | (CYRK) |
| Temperature | 23° C. | 23° C. |
| Printing ink | Manufacturer 1 | Manufacturer 1 |
| Carrier material | White paper | White paper |
| Pretreatment | None | Primer |

For printing, separation data 80-82 were calculated in each case from the color-space-profiled production data 70-72. It was possible to perform the printing of a digital image onto the carrier material with high quality for both sets of printing parameters. In addition, it was possible for color-space-profiled production data 70-72, and from these, separation data 80-82, to be calculated rapidly and effectively for the different sets of printing parameters. Changing printing parameters did not result in delays in the calculation of the separation data, as these were always calculated on the basis of the processed decoration raw data. The method according to the present disclosure is thus more cost-effective than the methods from the prior art.

### LIST OF REFERENCE DESIGNATIONS

10 analog decoration
20 device for creating a digital image
30 decoration raw data
40 PC for retouching
50 processed decoration raw data
60-62 set of printing parameters
70-72 color-space-profiled production data
80-82 separation data
90-92 carrier material

1. A method for digitally printing a decoration onto a carrier material by use of at least one set of defined printing parameters, the method comprising:
i. providing an analog decoration;
ii. from the analog decoration, generating and saving at least one digital image in the form of digital decoration raw data in the RGB color space;
iii. digitally processing at least a portion of the digital decoration raw data in the RGB color space and generating processed digital decoration raw data;
iv. providing at least one set of printing parameters;
v. transferring the processed digital decoration raw data and the at least one set of printing parameters to a color management or Raster Image Processor (RIP) software and calculating, from the processed digital decoration raw data, color-space-profiled production data for the at least one set of printing parameters;
vi. calculating separation data from the color-space-profiled production data calculated for the at least one set of printing parameters;
vii. outputting a digital image of the analog decoration with the calculated separation data onto a carrier material by use of a digital printer, wherein the digital printer is comprised by the at least one set of printing parameters for which a color-space-profiled production have been calculated
wherein the printing parameters in step iv. comprise the type of printing system, the color model to be used for printing, the temperature, the air humidity, the printing ink and/or the type of carrier material.

2. The method as claimed in claim 1, wherein the carrier material is selected from a group comprising paper, glass, metal, foils, wood-based materials, plastics and/or combinations thereof.

3. The method as claimed in claim 1, wherein in step ii., the digital decoration raw data are generated by photographing the analog decoration by means of a digital camera and/or by scanning-in the analog decoration by means of a scanner.

4. The method as claimed in claim 1, wherein in in step iii., in the digital processing of a least a portion of the decoration raw data are retouched.

5. The method as claimed in claim 4, wherein, in the retouching process,
a color tone of at least a portion of the decoration raw data is altered; and/or.
a brightness of at least a portion of the decoration raw data is altered; and/or.
a saturation of at least a portion of the decoration raw data is altered; and/or.
a contrast of at least a portion of the decoration raw data is altered; and/or.
a sharpness of at least a portion of the decoration raw data is altered.

6. The method as claimed in claim 1, wherein in step iii., a portion or the entirety of the decoration raw data is digitally processed.

7. The method as claimed in claim 1, wherein the processing of at least a portion of the digital decoration raw data in step iii. is effected by means of the Adobe Photoshop software.

8. The method as claimed in claim 1, wherein the printing parameters in step iv. also comprise the pretreatment of the carrier material.

9. The method as claimed in claim 1, wherein in step v., color-space-profiled production data are calculated for more than one set of printing parameters.

10. The method as claimed in claim 9, wherein in step vi., separation data are in each case calculated from the color-space-profiled production data calculated for each set of printing parameters and, in step vii., the digital image of the analog decoration, with the respectively calculated separation data, is output by respectively one digital printer onto a carrier material, wherein the respectively one digital printer is comprised by the set of printing parameters for which the color-space-profiled production data and the respective separation data were calculated.

11. The method as claimed in claim 1, wherein the carrier material is primed before being printed on.

12. The method as claimed in claim 1, wherein the carrier material, after having been printed on, is provided with a protective layer.

13. The method as claimed in claim 1, wherein the carrier material, after having been printed on, is supplied to a short-cycle press.

14. The method as claimed in claim 13, wherein the printed carrier material is provided with a textured surface structure.
